(19) United States
(12) Patent Application Publication
(10) Pub. No.: US 2006/0217082 A1
(43) Pub. Date: Sep. 28, 2006

(54) Shaping noise in power amplifiers of duplex communication systems

(76) Inventor: Georg Fischer, Nuremberg (DE)

Correspondence Address: WILLIAMS, MORGAN & AMERSON, 10333 RICHMOND, SUITE 1100, HOUSTON, TX, 77042, US

(21) Appl. No.: 11/085,989

(22) Filed: Mar. 22, 2005

(51) Int. Cl. H04B 1/04

(52) U.S. Cl. 455/114.2; 455/114.3

(57) ABSTRACT

The present invention provides a method and an apparatus for reducing radio frequency noise within a duplex communication system. The method comprises sensing a radio frequency transmit signal capable of operating a power amplifier that is capable of operation at a microwave transmit frequency and using a filter to cause an asymmetric notch in a noise power density spectrum in a radio frequency output signal to shape the noise power density spectrum at a low radio frequency power level in the microwave transmit frequency in response to the radio frequency transmit signal. In a base station, a duplex filter arrangement may trim the wideband noise within a power amplifier, such as a Class-S power amplifier. An increased filtering effort may be spend at a low power level at a power amplifier input. A desired noise shaping may be applied in the power amplifier to prevent desensitization of a receiver of a base station by the wideband noise at one or more receive frequencies for a digital cellular network in a telecommunication system. Use of a noise shaping filter with an asymmetric shape response may attenuate noise on a lower side of a transmit frequency and increase the noise on a higher side of the transmit frequency. A shift of the noise power to desired frequency regions, enables the base station to tolerate relatively more noise at higher frequencies than in a receive band, at frequencies that are lower than a transmit band. As a result, a Class-S power amplifier may provide both high linearity and efficiency.

### 1. FIELD OF THE INVENTION

This invention relates generally to telecommunications, and more particularly, to wireless communications.

### 2. DESCRIPTION OF THE RELATED ART

Wireless communication systems typically include one or more base stations (sometimes referred to as node-Bs) and a plurality of mobile units. The mobile units may include cellular telephones or other user equipment, such as desktop personal computers, laptop computers, personal data assistants, pagers, and the like. The base stations and the mobile units may exchange voice and/or data information over an air interface. To transmit the voice and/or data information, the base station or mobile unit encodes the information according to one or more wireless telecommunication protocols such as Universal Mobile Telephone System (UMTS) protocol, a Global System for Mobile communications (GSM) protocol, a Code Division Multiple Access (CDMA, CDMA 2000) protocol, and the like. The encoded information is then used to modulate an electromagnetic wave, which is transmitted across the air interface. For example, the carrier electromagnetic wave may be a 1 GHz radio frequency carrier wave.

The modulated carrier wave transmitted by a mobile unit may be relatively weak when it is received at a base station. The modulated carrier wave may also be obscured by various sources of noise, including noise introduced by the mobile unit and environmental noise. Accordingly, one or more antennas at the base station are typically coupled to one or more filters, which are tuned to the frequency of the carrier wave. For example, a base station antenna may be coupled to a 1 GHz radio frequency filter to reduce various noise components and thereby improve the selectivity of the base station to 1 GHz radio frequency carrier waves transmitted by the mobile units associated with the base station.

Most base stations use power amplifiers to provide a relatively high power gain to a wireless transmitter of a base station. However, growth of wireless communication systems has increased the demand for highly efficient amplifiers, for example, power amplifiers like radio frequency (RF) amplifiers. A power amplifier is an active, two-port device that exhibits both linear and non-linear behavior. Some features that characterize RF power amplifiers include high output power, high linearity, and high efficiency.

One type of power amplifiers commonly deployed in a base station is a Class-S amplifier due to their potential for high efficiency. Given the relative complexity of a RF application than most audio applications and sensitivity of RF signals, use of Class-S amplifiers presents many challenges in the RF communication applications. Nevertheless, Class-S amplifiers do offer a significantly high efficiency, e.g., in the order of 60 to 70% versus conventional amplifiers with efficiency at 10 to 20% and Doherty amplifiers around 30 to 35%.

FIG. 2 illustrates a conventional noise shaping characteristic 200 in a prior art radio frequency (RF) power amplifier that provides a symmetric noise shape. The high efficiency of the Class-S type amplifiers that use this symmetric noise shape comes at a price of an increased wideband noise generated by a transmitter in a base station, in CDMA or UMTS communication systems, for example. As base stations receive and transmit simultaneously, therefore, instead of a receive/transmit (RX/TX) switch, a duplex filter or a duplexer is used for such simultaneous operation. However, such a duplexer with high selectivity may prevent a receiver in the base station from being desensitized by the wideband noise at receive frequencies that a transmitter amplifier may generate. Conventionally, the selectivity of the duplexer is improved to prevent the desensitization of the receiver. The improved duplex filters result in duplexers with a larger form factor at an increased cost. Moreover, duplex filters with a higher selectivity increase signal losses, i.e., at least some benefit of the improved efficiency is lost.

The present invention is directed to overcoming, or at least reducing, the effects of, one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for reducing radio frequency noise within a duplex communication system. The method comprises sensing a radio frequency transmit signal capable of operating a power amplifier that is capable of operation at a microwave transmit frequency and using a filter to cause an asymmetric notch in a noise power density spectrum in a radio frequency output signal to shape the noise power density spectrum at a low radio frequency power level in the microwave transmit frequency in response to the radio frequency transmit signal.

In another embodiment, a base station associated with a duplex communication system comprises a transceiver including a receiver and a transmitter, the transmitter having an output and the receiver having an input. The base station further comprises a power amplifier that is characterized by a relatively higher efficiency operation at a microwave transmit frequency, wherein the power amplifier having an input and an output. At the base station, a duplex filter may process receive and transmit signals simultaneously. The duplex filter may be capable of applying noise shaping to a radio frequency transmit signal in the power amplifier to cause an asymmetric notch in a noise power density spectrum in a radio frequency output signal to shape the noise power density spectrum at a low radio frequency power level in the microwave transmit frequency in response to the radio frequency transmit signal, wherein the output of the transmitter is coupled to the input of the power amplifier and the output of the power amplifier is coupled to the filter and the receiver is coupled to the filter.

In yet another embodiment, a Class-S amplifier having an output comprises a bandpass sigma-delta modulator having an output. The Class-S amplifier includes a low power filter coupled to the bandpass sigma-delta modulator. The low power filter determines a noise shape at the output of the Class-S amplifier for a radio frequency transmit signal at a transmit frequency. The Class-S amplifier further includes a bandpass filter having an input, wherein the bandpass filter is coupled at the output of the Class-S amplifier to provide a radio frequency output signal. In the Class-S amplifier, a switching amplifier couples the output of the bandpass sigma-delta modulator to the input of the bandpass filter and a noise shaping filter is coupled to the bandpass sigma-delta modulator. The noise shaping filter causes an asymmetric shape response to attenuate noise on a lower side of the transmit frequency and increase the noise on a higher side of the transmit frequency.

In still another embodiment, a radio frequency front end is provided for a base station. The radio frequency front end comprises an integrated transceiver that includes a power amplifier and a transceiver having a receiver and a transmitter. The radio frequency front end further comprises a duplex filter coupled to the integrated transceiver and an antenna that may be coupled to the duplex filter.

In one illustrative embodiment, a duplex communication system comprises a base station that includes a transceiver including a receiver and a transmitter, the transmitter having an output and the receiver having an input. The base station further comprises a power amplifier that is characterized by a relatively higher efficiency operation at a microwave transmit frequency, wherein the power amplifier having an input and an output. A duplex filter may process receive and transmit signals simultaneously at the base station. The duplex filter may be capable of applying noise shaping to a radio frequency transmit signal in the power amplifier to cause an asymmetric notch in a noise power density spectrum in a radio frequency output signal to shape the noise power density spectrum at a low radio frequency power level in the microwave transmit frequency in response to the radio frequency transmit signal, wherein the output of the transmitter is coupled to the input of the power amplifier and the output of the power amplifier is coupled to the filter and the receiver is coupled to the filter.

In an exemplary embodiment, an apparatus for reducing radio frequency noise within a duplex communication system may comprise means for sensing a radio frequency transmit signal capable of operating a power amplifier that is capable of operation at a microwave transmit frequency and means for using a filter to cause an asymmetric notch in a noise power density spectrum in a radio frequency output signal to shape the noise power density spectrum at a low radio frequency power level in the microwave transmit frequency in response to the radio frequency transmit signal.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a duplex communication system including a wireless network to communicate with a base station having a power amplifier that is characterized by a relatively higher efficiency operation at a microwave transmit frequency for reducing noise according to one illustrative embodiment of the present invention;

FIG. 2 illustrates a conventional noise shaping characteristic in a prior art radio frequency (RF) power amplifier;

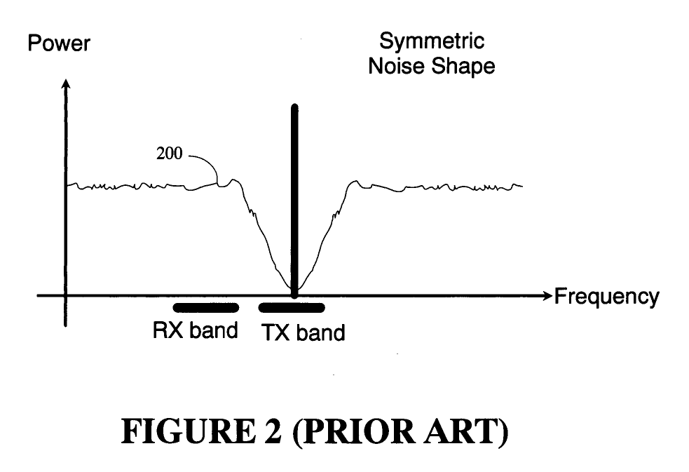

FIG. 3 schematically depicts a Class-S power amplifier as the power amplifier shown in FIG. 1 consistent with one embodiment of the present invention;

FIG. 4 schematically depicts a duplexer that uses the Class-S power amplifier shown in FIG. 3 in accordance with one embodiment of the present invention;

FIG. 5 illustrates an asymmetric noise shaping characteristic of the Class-S power amplifier shown in FIG. 3 according to an exemplary embodiment of the instant invention;

FIG. 6 schematically depicts a frequency agile Class-S amplifier as the power amplifier shown in FIG. 1 consistent with one embodiment of the present invention; and

FIG. 7 illustrates a stylized representation of a method for reducing noise in the Class-S amplifier shown in FIG. 3 within the duplex communication system shown in FIG. 1 according to one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and apparatus is provided for reducing noise in power amplifiers, such as Class-S power amplifiers based on an asymmetric noise shaping within duplex communication systems. In one embodiment, a radio frequency (RF) front end in a base station may comprise an integrated transceiver that includes a power amplifier (PA). The integrated transceiver may include a transceiver having a base station receiver and a base station transmitter. By combining the power amplifier in the integrated transceiver, the RF front end may obviate reliance of the base station on external amplifiers. A duplex filter arrangement may couple the power amplifier and the receiver to an antenna and isolate the transmitter and an associated PA from the receiver. The duplex filter arrangement may trim the noise shape of a wideband noise generated inherently by the power amplifier. An increased filtering effort may be spend at a low power level at a power amplifier input. A desired noise shaping may be applied in the power amplifier. In this manner, this trimming of the noise shape may prevent desensitization of a receiver of a base station by the wideband noise at one or more receive frequencies for a digital cellular network in a telecommunication system. Use of a noise shaping filter with an asymmetric shape response may attenuate noise on a lower side of a transmit frequency and increase the noise on a higher side of the transmit frequency. A shift of the noise power to desired frequency regions, enables the base station to tolerate relatively more noise at higher frequencies than in a receive (RX) band, at frequencies that are lower than a transmit (TX) band. By shaping the noise, a high noise level in a receive band may be avoided, obviating the use of a higher order TX section in a duplex filter. As a result, high losses in the TX section of the duplex filter may be avoided without degrading the effective usable efficiency of a Class-S power amplifier. Therefore, a Class-S power amplifier may be provided with both relatively high linearity and efficiency.

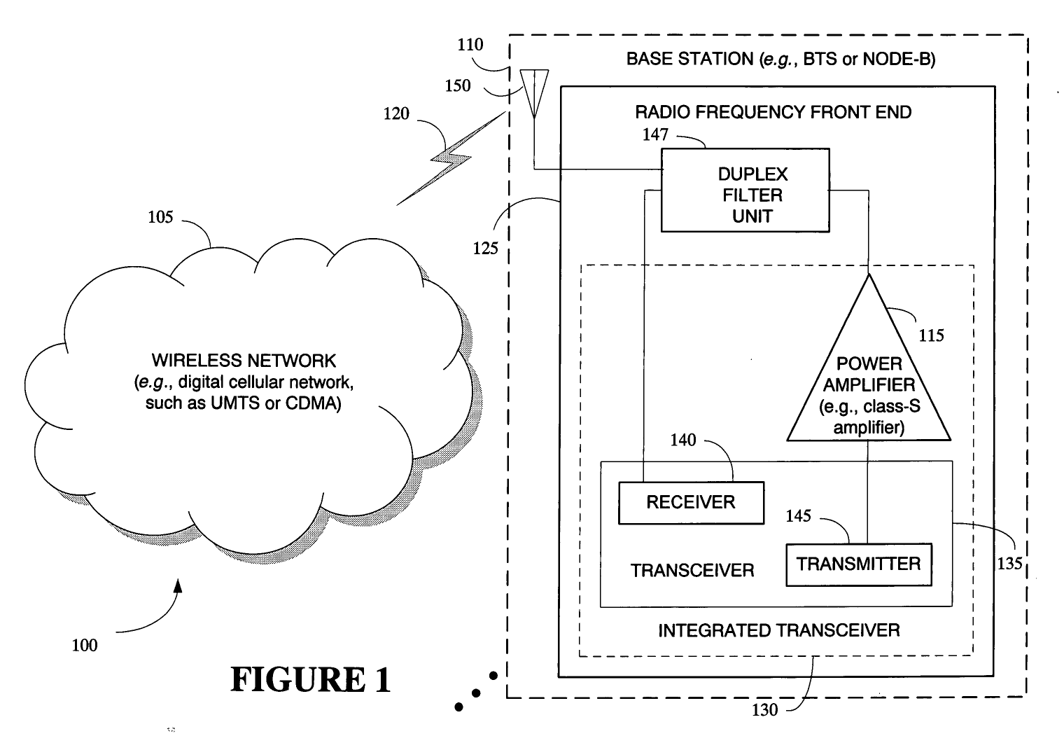

Referring to FIG. 1, to reduce noise associated with wireless communications, for example, within a wireless telecommunication system, a duplex communication system 100 is schematically depicted according to one illustrative embodiment of the present invention. In the duplex communication system 100, a wireless network 105 may enable radio frequency (RF) communications with a base station 110 (e.g., Node-B) comprising a power amplifier 115 that is characterized by a relatively higher efficiency operation at a microwave transmit frequency. For example, a wireless communication 120 to and from the base station 110 over the wireless network 105 may be consistent with a digital cellular network. The wireless communication 120 may be transmitted across an air interface, for example, using a 1 Giga Hertz (GHz) radio frequency (RF) carrier wave. One example of the power amplifier 115 is a Class-S power amplifier.

In accordance with one embodiment, the power amplifier 115 may be a radio frequency (RF) amplifier defined, at least in part, based on Orthogonal Frequency Division Multiplexing (OFDM)—a multi-carrier modulation technique for broadband wireless communications or a Code Division Multiple Access (CDMA) standard or a combination thereof in the wireless network 105 based on a particular application. Consistent with another embodiment, the power amplifier 115 may be an RF amplifier defined at least in part based on a Time Division (TD)—CDMA standard in the wireless network 105. In this way, the base station 110 may send or receive, voice, data, or a host of voice and data services in different generations of the wireless network 105, including a digital cellular network based on one or more standards.

The duplex communication system 100 may be defined, at least in part, by a Third Generation (3G) mobile communication standard based on a UMTS protocol, in one embodiment. Alternatively, the wireless communication 120 in the duplex communication system 100 may be defined, at least in part, according to a CDMA protocol or a Global System for Mobile Communications (GSM) protocol, which is a land mobile pan-European digital cellular radio communications system.

In one embodiment, a radio frequency (RF) front end 125 may be disposed at the base station 110. The RF front end 125 may comprise an integrated transceiver 130 that includes the power amplifier (PA) 115. The power amplifier 115 may be coupled to a transceiver 135 having a base station receiver 140 and a base station transmitter 145. The integrated transceiver 130 essentially combines the transceiver 135 and the power amplifier 115 on a shared common module, obviating reliance on external amplifiers. The RF front end 125 may further comprise a duplex filter arrangement or unit 147 that may be coupled to the power amplifier 115 and the receiver 140. At the RF front end 125, an antenna 150 may be coupled to the duplex filter arrangement or unit 147 may process receive and transmit signals simultaneously at the base station 110.

The duplex communication system 100 may provide for trimming of the noise shape of the wideband noise generated inherently by the power amplifier 115. Filtering effort may not be spend at the power amplifier 115 output at a high power level instead an increased filter effort may be spend at a low power level at the power amplifier 115 input. A desired noise shaping may be applied in the power amplifier 115 instead of using a relatively high performance duplexer by trimming the spectral shape of the wideband noise within the power amplifier 115 at the base station 110. This trimming of the spectral noise shape may prevent desensitization of the base station receiver 140 of the base station 110 by the wideband noise at one or more receive frequencies being generated by the power amplifier 115 associated with the base station transmitter 145.

Accordingly, in some embodiments, the power amplifier 115 may comprise a switch mode amplifier and a modulator for reducing the noise in a receive band (RX). In the modulator, a noise shaping filter may be responsible for radio frequency noise reduction in the RX band. The noise shaping filter may cause an asymmetric noise shape when embedded in a feedback loop. Therefore, instead of using a duplex filter alone with relatively high rejection of radio frequency noise around receive frequencies in a TX path that leads to a costly duplex filter because of the filter effort at a high RF power level, the noise shaping filter may be deployed as part to the modulator to implement complex filter functions at a low RF power level. While use of the filter effort in the duplexer generally results losses which degrades the efficiency of the power amplifier 115, an additional filter effort in the modulator may not affect the efficiency of the power amplifier 115.

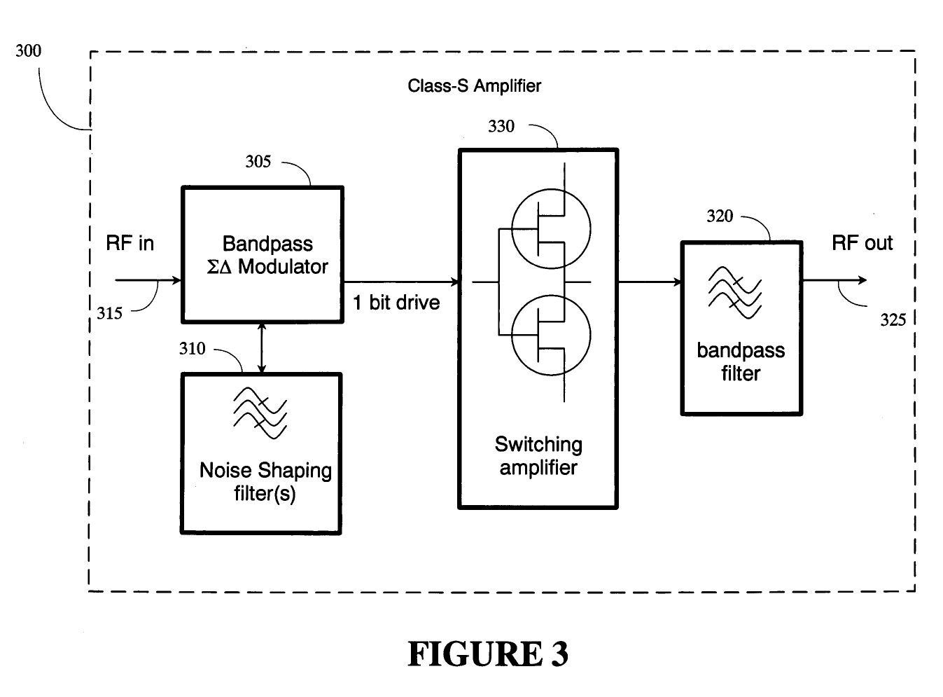

Turning now to FIG. 3, a Class-S power amplifier 300 is schematically depicted consistent with one embodiment of the present invention. The Class-S power amplifier 300 may be used, as the power amplifier 115 shown in FIG. 1, within the duplex communication system 100. The Class-S power amplifier 300 having an output may comprise a bandpass sigma-delta modulator 305 having an output. The bandpass delta-sigma modulator 305 may comprise an analog to digital (A/D) converter and a feedback structure in which the quantization noise is spectrally shaped to shift beyond the passband. The Class-S power amplifier 300 may further include a low power filter, such as a noise shaping filter 310 coupled to the bandpass sigma-delta modulator 305. The noise shaping filter 310 determines a noise shape at the output of the Class-S power amplifier 300 for a radio frequency (RF) transmit signal 315 at a transmit frequency.

The Class-S power amplifier 300 further includes a bandpass filter 320 having an input, wherein the bandpass filter 320 may be coupled at the output of the Class-S power amplifier 300 to provide a RF output signal 325. In the Class-S power amplifier 300, a switching amplifier 330 may couple the output of the bandpass sigma-delta modulator 305 to the input of the bandpass filter 320 and the noise shaping filter 310 may be coupled to the bandpass sigma-delta modulator 305.

In operation, the Class-S power amplifier 300 may amplify an incoming signal, such as the RF transmit signal 315 to a two-state signal that may be noise shaped using the noise shaping filter 310 at the output of the bandpass sigma-delta modulator 305. Using the bandpass delta-sigma modulator 305, the Class-S power amplifier 300 may convert the RF transmit signal 315 to a digital signal, i.e., a 1-bit drive. This two-level signal may then be fed into the switching amplifier 330 and subsequently passed to the bandpass filter 320.

The input of the switching amplifier 330 may be driven by the bandpass delta-sigma modulated signal with the use of the bandpass delta-sigma modulator 305. Consistent with on embodiment, in this manner, the noise shaping filter 310 causing an asymmetric shaping of the notch within the noise power density spectrum, a lower side of the transmit frequency is attenuated and the noise on a higher side of the transmit frequency is increased. As a result, the Class-S power amplifier 300 may provide both high linearity and efficiency.

An additional filter effort may not be spend at the Class-S power amplifier 300 output at a high power level instead an increased filter effort may be spend at a low power level around the bandpass sigma-delta modulator 305. The noise shaping filter 310 along with the bandpass sigma-delta modulator 305 may match a noise specification at a system level based on a desired performance and standards deployed in the duplex communication system 100. The duplex communication system 100 may avoid highly selective filtering at the high power level, high complexity, a relatively large form factor, use of expensive duplex filters by providing a degree of freedom for trimming the noise shape of the wideband noise generated inherently by the Class-S power amplifier 300.

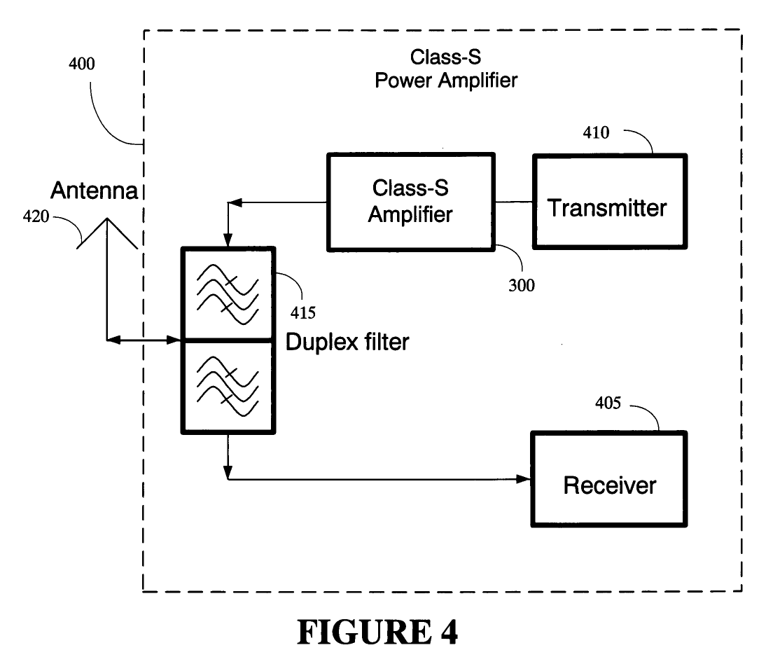

Referring to FIG. 4, an RF system 400 is schematically depicted and uses the Class-S power amplifier 300 shown in FIG. 3 in accordance with one embodiment of the present invention. The RF system 400 comprises a receiver 405 and a transmitter 410, the transmitter 410 having an output and the receiver 405 having an input, respectively. The RF system 400 for use in the base station 110 may further comprise the Class-S power amplifier 300 that is characterized by a relatively higher efficiency operation.

The Class-S power amplifier 300 having an input and an output may couple the transmitter 410 to a duplex filter 415 that may receive and transmit signals simultaneously at the base station 110. The duplex filter 415 may be capable of applying noise shaping to the RF transmit signal 315 in the Class-S power amplifier 300 to cause an asymmetric spread of a notch in a noise power density spectrum in the RF output signal 325 to shape the notch in a noise power density spectrum in response to the RF transmit signal 315. An antenna 420 may be coupled to the duplex filter 415, in one embodiment. While the output of the transmitter 410 may be coupled to the input of the Class-S power amplifier 300, the output of the Class-S power amplifier 300 is coupled to the duplex filter 415 and the input of the receiver 405 is coupled to the duplex filter 415.

In operation, a level of a wideband noise being generated by the transmitter 410 may be determined. Rather than using a relatively high performance duplexer, a desired noise shaping may be applied in the Class-S amplifier 115 by trimming a wideband noise spectrum within the Class-S amplifier 115. This trimming of the wideband noise spectrum may prevent desensitization of the receiver 405 by the wideband noise at one or more receive frequencies being generated by the Class-S amplifier 115 associated with the transmitter 410.

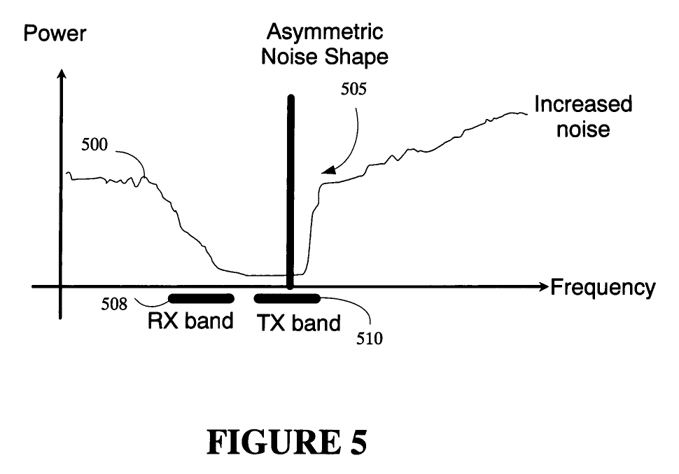

As shown, FIG. 5 illustrates an asymmetric noise shaping characteristic 500 of the Class-S power amplifier 300 shown in FIG. 3 according to an exemplary embodiment of the instant invention. The Class-S power amplifier 300 causes an asymmetric noise shape 505 across a transmit (TX) band 510. In response to the RF transmit signal 315, this asymmetric noise shape 505 may asymmetrically spread the notch in a noise power density spectrum in the RF output signal 325 for the purposes of shaping the notch in a noise power density spectrum.

By applying the noise shaping filter 310, as shown in FIG. 3, with an asymmetric shape response within Class-S power amplifier 300 the frequency of the notch in a noise power density spectrum may be shifted across the TX band 510 to at least a first frequency region where the noise minimally affects the duplex communication system 100 and a second frequency region where the noise is substantially filtered out. In other words, a filtering effort on the RF transmit signal 315 may be increased near the input of the Class-S power amplifier 300 at a lower power level while the filtering effort on the RF transmit signal 315 may be reduced at the output of the Class-S power amplifier 300 at a higher power level.

The noise shaping filter 310 may determine the noise shape at the output of the Class-S power amplifier 300. By applying a low power filter, i.e., the noise shaping filter 310 causing an asymmetric shape response, the increased noise at higher frequencies may be filtered out with the low power filter. The Class-S power amplifier 300 may comprise one bit A/D converter that inherently is associated to noise. However, the noise power of the total amount of noise given by the one bit A/D converter may be spread along the frequency axis. That is, a shift of the noise power to desired frequency regions, enables the base station 110 to tolerate relatively more noise at higher frequencies than in a receive (RX) band 508, at frequencies that are lower than the TX band 510.

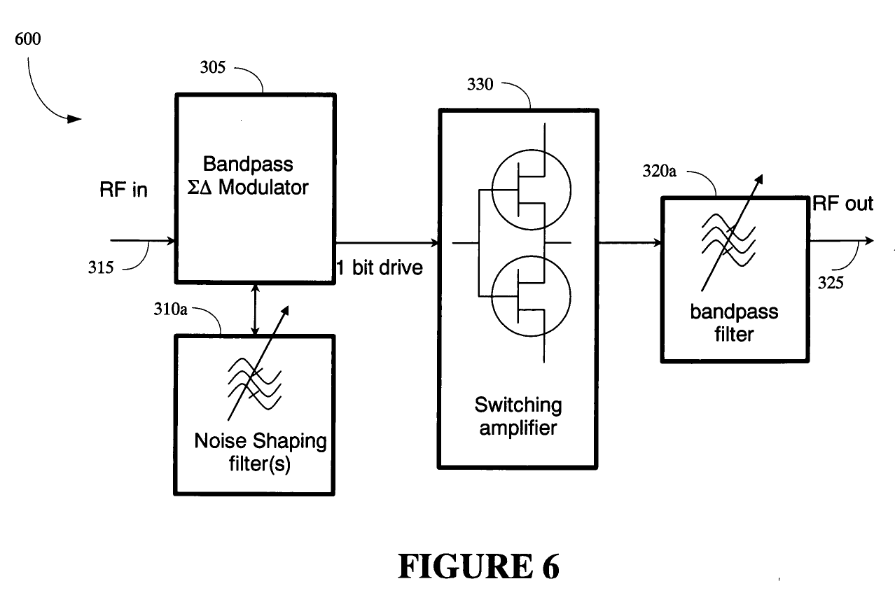

Referring to FIG. 6, a frequency agile Class-S amplifier 600 is schematically depicted for use as the power amplifier 115 shown in FIG. 1 consistent with one embodiment of the present invention. The noise shaping filter 310a and the bandpass filter 320a may be tunable filters. Using such tunable filters, a frequency agile multi-band high efficiency amplifier may be realized, in one embodiment. To provide the frequency agility, an operating frequency may be synthesized across the TX band 510 in frequency steps selected via a programmable noise shaping filter 310a and a programmable bandpass filter 320a.

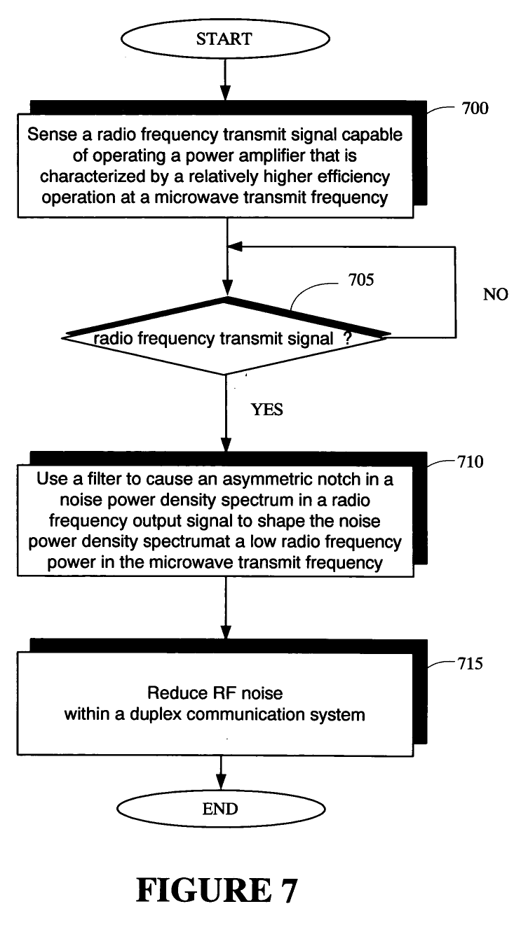

Finally, FIG. 7 shows a stylized representation of a method for reducing noise in the Class-S power amplifier 300 shown in FIG. 3 within the duplex communication system 100 shown in FIG. 1 according to one illustrative embodiment of the present invention. At block 700, the RF transmit signal 315 being fed into the Class-S power amplifier 300 may be sensed. The RF transmit signal 315 may be capable of operating a power amplifier that is characterized by a relatively higher efficiency operation at a microwave transmit frequency. A decision block 705 may interpret the RF transmit signal 315 for the base station 110 in the duplex communication system 100. In response to the RF transmit signal 315, at block 710, the noise shaping filter 310 may cause an asymmetric spread of a notch in a noise power density spectrum at a low radio frequency power in the microwave transmit frequency in the RF output signal 325, shaping the notch in a noise power density spectrum. The radio frequency noise in the Class-S power amplifier 300 may be reduced within the duplex communication system 100, as indicated at block 715

According to some embodiments of the present invention, for the Class-S power amplifier 300 capable of operating at a microwave transmit frequency, a substantially high efficiency may be offered, especially within a CDMA or a UMTS system without a drawback of filtering the wideband noise in the RF system 400 to prevent the receiver 405 form desensitization. By applying the asymmetric noise shaping in the Class-S power amplifier 300, use of a high performance duplexer may be avoided. A high efficiency amplification together with a relatively low requirement for filtering at the duplex filter 415 may enable a cost efficient design for the base station 110, in one embodiment.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for reducing radio frequency noise within a duplex communication system, the method comprising:
sensing a radio frequency transmit signal capable of operating a power amplifier that is capable of operation at a microwave transmit frequency; and
in response to said radio frequency transmit signal, using a filter to cause an asymmetric notch in a noise power density spectrum in a radio frequency output signal to shape said noise power density spectrum at a low radio frequency power level in said microwave transmit frequency.

2. A method for claim 1, wherein using a filter to cause an asymmetric notch further comprising:
applying said filter that causes an asymmetric shape response within said power amplifier to shift frequency of the notch in a noise power density spectrum in said power amplifier across a transmit band to at least a first frequency region where the noise minimally affects said duplex communication system and a second frequency region where the noise is substantially filtered out.

3. A method for claim 1, further comprising:
disposing a Class-S amplifier having an input and an output for said power amplifier and a bandpass sigma-delta modulator at the input of said Class-S amplifier, said Class-S amplifier is characterized by a relatively higher efficiency operation at said microwave transmit frequency.

4. A method for claim 3, further comprising:
disposing a Class-S amplifier having an input and an output for said power amplifier and a bandpass sigma-delta modulator at the input of said Class-S amplifier.

5. A method for claim 4, further comprising:
increasing a filtering effort on said radio frequency transmit signal near the input of said Class-S amplifier at a lower power level.

6. A method for claim 5, further comprising:
reducing the filtering effort on said radio frequency transmit signal at the output of said Class-S amplifier at a higher power level.

7. A method for claim 3, further comprising:
applying a desired shaping of noise power density spectrum in said Class-S amplifier instead of using a relatively high performance duplexer.

8. A method for claim 1, further comprising:
disposing said power amplifier in a base station associated with said duplex communication system; and
trimming the spectral shape of the wideband noise within said power amplifier in said base station.

9. A method for claim 1, further comprising:
disposing in a radio frequency front end a duplex filter and an integrated transceiver that includes said power amplifier and a transceiver including a receiver and a transmitter for a base station; and
determining a level of the wideband noise being generated by said transmitter of said base station in said duplex communication system.

10. A method for claim 9, further comprising:
preventing desensitization of said receiver of said base station by the wideband noise at one or more receive frequencies being generated by said power amplifier associated with said transmitter.

11. A base station associated with a duplex communication system, said base station comprising:
a transceiver including a receiver and a transmitter, said transmitter having an output and said receiver having an input;
a power amplifier that is characterized by a relatively higher efficiency operation at a microwave transmit frequency, said power amplifier having an input and an output; and
a duplex filter to process receive and transmit signals simultaneously at said base station, said filter is capable of applying noise shaping to a radio frequency transmit signal in said power amplifier to cause an asymmetric notch in a noise power density spectrum in a radio frequency output signal to shape the noise power density spectrum at a low radio frequency power level in said microwave transmit frequency in response to the radio frequency transmit signal, wherein said output of said transmitter is coupled to said input of said power amplifier and said output of said power amplifier is coupled to said filter and said receiver is coupled to said filter.

12. A Class-S amplifier having an output, said Class-S amplifier comprising:
a bandpass sigma-delta modulator having an output;
a low power filter coupled to said bandpass sigma-delta modulator, said low power filter to determine a noise shape at the output of said Class-S amplifier for a radio frequency transmit signal at a transmit frequency;
a bandpass filter having an input, said bandpass filter is coupled at the output of said Class-S amplifier to provide a radio frequency output signal; and
a switching amplifier that couples the output of said bandpass sigma-delta modulator to the input of said bandpass filter; and
a noise shaping filter is coupled to said bandpass sigma-delta modulator, wherein said noise shaping filter causing an asymmetric shape response to attenuate noise on a lower side of the transmit frequency and increase the noise on a higher side of the transmit frequency.

13. A Class-S amplifier, as set forth in claim 12, wherein said noise shaping filter includes a tunable noise shaping filter and said bandpass filter includes a tunable bandpass filter to provide frequency agility in said Class-S amplifier.

14. A radio frequency front end for a base station, said radio frequency front end comprising:
an integrated transceiver coupled to a power amplifier, wherein said integrated transceiver including a transceiver having a receiver and a transmitter;
a duplex filter coupled to said integrated transceiver; and
an antenna coupled to said duplex filter.

15. A radio frequency front end, as set forth in claim 14, wherein said power amplifier includes a Class-S power amplifier.

16. A duplex communication system comprising:
a base station including:
a transceiver including a receiver and a transmitter, said transmitter having an output and said receiver having an input;
a power amplifier that is characterized by a relatively higher efficiency operation at a microwave transmit frequency, said power amplifier having an input and an output; and
a duplex filter to process receive and transmit signals simultaneously at said base station, said filter is capable of applying noise shaping to a radio frequency transmit signal in said power amplifier to cause an asymmetric notch in a noise power density spectrum in a radio frequency output signal to shape the noise power density spectrum at a low radio frequency power level in said microwave transmit frequency in response to the radio frequency transmit signal, wherein said output of said transmitter is coupled to said input of said power amplifier and said output of said power amplifier is coupled to said filter and said receiver is coupled to said filter.

17. A duplex communication system, as set forth in claim 16, wherein said power amplifier includes a Class-S power amplifier.

18. A duplex communication system, as set forth in claim 16, wherein said duplex communication system is being defined at least in part by a Universal Mobile Telecommunication System (UMTS) standard.

19. A duplex communication system, as set forth in claim 16, wherein said duplex communication system is being defined at least in part by a Code Division Multiple Access (CDMA) standard.

20. An apparatus for reducing radio frequency noise within a duplex communication system, the apparatus comprising:
means for sensing a radio frequency transmit signal capable of operating a power amplifier that is capable of operation at a microwave transmit frequency; and
means for using a filter to cause an asymmetric notch in a noise power density spectrum in a radio frequency output signal to shape the noise power density spectrum at a low radio frequency power level in the microwave transmit frequency in response to the radio frequency transmit signal.
